(19) United States
(12) Patent Application Publication
(10) Pub. No.: US 2026/0011941 A1
(43) Pub. Date: Jan. 8, 2026

(54) QUICK CONNECTION STRUCTURE AND METHOD FOR CONDUCTIVE WIRE AND CONNECTION TERMINAL

(71) Applicants: NEXTRONICS ENGINEERING CORP., NEW TAIPEI CITY (TW); MAKALOT INDUSTRIAL CO., LTD., Taipei City (TW)

(72) Inventors: HOU-AN SU, KEELUNG CITY (TW); KUAN-WEN CHEN, NEW TAIPEI CITY (TW); YU-TING SUN, Keelung City (TW); WEI-YI TSAI, Taipei City (TW); LI-XIANG LEE, Taipei City (TW)

(21) Appl. No.: 18/950,184

(22) Filed: Nov. 18, 2024

(30) Foreign Application Priority Data
Jul. 4, 2024 (TW) 113125015

(51) Int. Cl. H01R 12/65; H01R 12/62; H01R 43/20

(52) U.S. Cl. CPC H01R 12/65; H01R 12/62; H01R 43/20

(57) ABSTRACT

Quick connection structure and method for a conductive wire and a connection terminal are provided. The quick connection structure includes at least one conductive wire, at least one fork-shaped terminal, and the connection terminal. One end of the fork-shaped terminal has a fork portion. The connection terminal is disposed on a connector body or a flexible board body and has a terminal body, and at least one mounting hole is formed on the terminal body. During assembly, the conductive wire is inserted into channels of jigs to allow the conductive wire arranged horizontally to be arranged vertically. The fork-shaped terminal is pressed into the jig to cover the conductive wire. The conductive wire and the fork-shaped terminal are pressed into the mounting hole of the connection terminal. A material tape of a row of the fork-shaped terminal is removed along a break line of the fork-shaped terminal.

### CROSS-REFERENCE TO RELATED PATENT APPLICATION

This application claims the benefit of priority to Taiwan Patent Application No. 113125015, filed on Jul. 4, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a quick connection structure and method for a conductive wire and a connection terminal, and more particularly to a connection structure and method that can connect a conductive wire to a connection terminal and be used for electrical signal transmission.

### BACKGROUND OF THE DISCLOSURE

A yarn conductive wire is made of a yarn and a metal wire wound in a spiral manner, and has the characteristics of stretchability and conductivity. If the yarn conductive wire is applied to fabric, signals from various parts of the body can be transmitted to a device center for processing without losing the stretchability of the fabric, allowing the yarn conductive wire to be used in products such as functional clothing. Generally, a connection of electrical signals between different carriers is achieved by soldering, where a metal medium is added between conductors to transmit electrical signals. However, the spinning yarn is not resistant to high temperatures, and when electrical signal transmission is required, it is necessary to develop a new and quickly implementable connection method.

### SUMMARY OF THE DISCLOSURE

In response to the above-referenced technical inadequacies, the present disclosure provides a quick connection structure and a quick connection method for a conductive wire and a connection terminal, so as to connect and fix the conductive wire and the connection terminal without using solder and be environmentally-friendly. Furthermore, the quick connection structure and method can be used to process materials that are not resistant to high temperature, and can achieve effects of convenient and fast for being used in mass production.

In order to solve the above-mentioned problems, one of the technical aspects adopted by the present disclosure is to provide a quick connection structure. The quick connection structure includes at least one conductive wire, at least one fork-shaped terminal, and at least one connection terminal. One end of the fork-shaped terminal has a fork portion, the fork portion is bifurcated, and an accommodation space is defined in the fork portion. The connection terminal has a terminal body, at least one mounting hole is formed in the terminal body, the mounting hole extends to one end of the terminal body, and a wire diameter of the conductive wire is smaller than a diameter of the mounting hole. The conductive wire is accommodated in the accommodation space of the fork-shaped terminal, the fork portion of the fork-shaped terminal and the conductive wire are pressed into the mounting hole of the connection terminal, and the fork portion of the terminal and the mounting hole of the connection terminal form an interference fit. The conductive wire is clamped in the fork portion of the fork-shaped terminal, so that the conductive wire is connected and fixed to the connection terminal.

In order to solve the above-mentioned problems, another one of the technical aspects adopted by the present disclosure is to provide a quick connection method for a conductive wire and a connection terminal. The quick connection method includes: providing at least one conductive wire, at least one fork-shaped terminal, and a connection terminal, in which one end of the fork- shaped terminal has a fork portion, the fork portion is bifurcated, and an accommodation space is defined in the fork portion; in which the connection terminal has a terminal body, at least one mounting hole is formed in the terminal body, the mounting hole extends to one end of the terminal body, and a wire diameter of the conductive wire is smaller than a diameter of the mounting hole; accommodating the conductive wire in the accommodation space of the fork-shaped terminal; and pressing the fork portion of the fork-shaped terminal and the conductive wire into the mounting hole of the connection terminal, so that the fork portion of the fork-shaped terminal and the mounting hole of the connection terminal form an interference fit; in which the conductive wire is clamped in the fork portion of the fork-shaped terminal, so that the conductive wire is connected and fixed to the connection terminal.

Therefore, in the quick connection structure and the quick connection method for a conductive wire and a connection terminal provided by the present disclosure, the quick connection structure includes at least one conductive wire, at least one fork-shaped terminal, and at least one connection terminal. One end of the fork-shaped terminal has a fork portion, and an accommodation space is defined in the fork portion. The connection terminal includes a terminal body, at least one mounting hole is formed in the terminal body, the at least one mounting hole extends to one end of the terminal body, and a wire diameter of the conductive wire is smaller than a diameter of the mounting hole. The conductive wire is accommodated in the accommodation space of the fork-shaped terminal, the fork portion of the fork-shaped terminal and the conductive wire are pressed into the mounting hole of the connection terminal, and the fork portion of the terminal and the mounting hole of the connection terminal form an interference fit. The conductive wire is clamped in the fork portion of the fork-shaped terminal, so that the conductive wire is connected and fixed to the connection terminal. Accordingly, by the guiding of the fork-shaped terminal and friction force at the outer side of the fork-shaped terminal, pressing the fork portion into the mounting hole is smooth and pulling the fork portion out of the mounting hole is difficult. That is, the fork-shaped terminal that remains in the mounting hole exerts a force of expansion providing a friction force to an inner wall of the mounting hole, thereby effectively preventing the conductive wire from being pulled out. The quick connection structure and the quick connection method for a conductive wire and a connection terminal provided by the present disclosure can connect and fix the conductive wire and the connection terminal in a quick and simple assembly without using solder and be environmentally- friendly. Furthermore, the quick connection structure and method can be used to process materials that are not resistant to high temperature, and can achieve effects of convenient and fast for being used in mass production.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a perspective exploded view of a quick connection structure for a conductive wire and a connection terminal according to the present disclosure;

FIG. 2 is a perspective exploded view of a connector according to the present disclosure;

FIG. 3 is a schematic diagram of inserting the conductive wire into a jig according to the present disclosure;

FIG. 4 is a perspective exploded view of the quick connection structure for the conductive wire and the connection terminal including a material tape according to the present disclosure;

FIG. 5 is a perspective view of the quick connection structure for the conductive wire and the connection terminal according to the present disclosure;

FIG. 6 is another perspective view of the quick connection structure for the conductive wire and the connection terminal according to the present disclosure;

FIG. 7 is a cross-sectional view taken along line VII-VII of FIG. 5;

FIG. 8 is a perspective view of the quick connection structure for the conductive wire and the connection terminal according to one embodiment of the present disclosure;

FIG. 9 is a perspective view of the quick connection structure for the conductive wire and the connection terminal according to another embodiment of the present disclosure; and

FIG. 10 is a flowchart of a quick connection method for the conductive wire and the connection terminal according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Embodiments

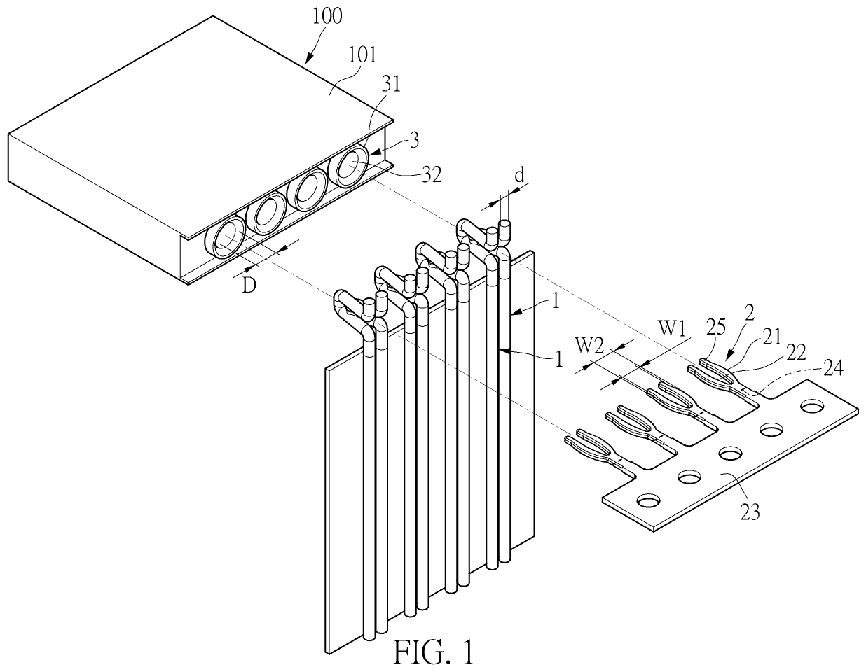

Referring to FIG. 1, the present disclosure provides a quick connection structure for a conductive wire and a connection terminal, and the quick connection structure includes at least one conductive wire 1, at least one fork-shaped terminal 2, and a connection terminal 3.

The conductive wire 1 is preferably a very thin wire, such as having a diameter of 40 in American wire gauge (AWG) or thinner. The conductive wire 1 can also be a yarn conductive wire that includes a yarn and a metal wire (not shown) wound in a spiral manner. The conductive wire 1 is an extendable and conductive yarn wire structure, and has the properties of extendibility and electrical conductivity. Since the conductive wire 1 is an existing technology and the present disclosure does not limit a structure of the conductive wire 1, it will not be described in detail herein. The quantity of the conductive wire 1 is not limited, and one or more conductive wires 1 can be provided. Multiple conductive wires 1 are provided in this embodiment to have a larger transmission capacity. The conductive wires 1 are arranged horizontally and bonded in pairs, such that two conductive wires 1 can be assembled together in a same mounting hole 32.

The fork-shaped terminal 2 is substantially in a shape of a harpoon. One end of the fork-shaped terminal 2 has a fork portion 21, and the fork portion 21 is bifurcated. An accommodation space 22 is defined in the fork portion 21 and can be used to accommodate the conductive wire 1. Preferably, a width of the accommodation space 22 tapers inward, such that the conductive wire 1 can be gradually clamped when being placed in the accommodation space 22 to have better fixing and conduction effects.

The fork portion 21 can be connected to a material tape 23. A break line 24 is disposed between the fork portion 21 and the material tape 23. The fork-shaped terminal 2 is connected to the material tape 23, such that the fork- shaped terminal 2 is driven by the material tape 23 to be assembled on the connection terminal 3. After the fork portion 21 of the fork-shaped terminal 2 and the conductive wire 1 are pressed into the mounting hole 32 of the connection terminal 3, the fork portion 21 and the material tape 23 can be separated by breaking along the break line 24.

A guide portion 25 can be formed at one end of the fork portion 21 away from the material tape 23. A width W1 of the guide portion 25 is smaller than a width W2 of the fork portion 21, and the guide portion 25 is rounded, so as to provide better guiding effect to enable the fork portion 21 of the fork-shaped terminal 2 to smoothly insert into the mounting hole 32. Multiple fork-shaped terminals 2 can be connected to one material tape 23, such that multiple conductive wires 1 can be respectively mounted in multiple mounting holes 32 of the connection terminal 3 simultaneously, thereby achieving mass production feasibility. Furthermore, the number of conductive wires installed in mounting holes in a single installation can also be adjusted according to the number of the mounting holes 32 of the connection terminal 3.

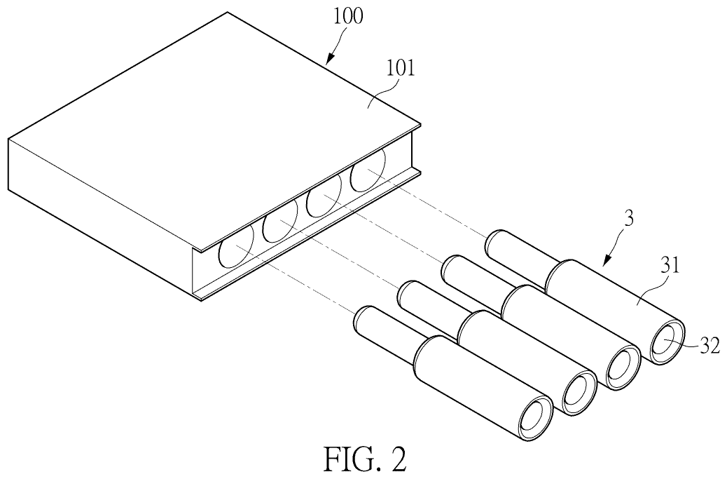

The connection terminal 3 may be a terminal of a connector 100 (as shown in FIG. 1 and FIG. 2), and the connector 100 is an electrical connector. The connector 100 includes a connector body 101, and the connector body 101 can be an insulator. A plurality of connection terminals 3 are installed in the connector body 101. However, the connection terminals 3 of the present disclosure are not limited to being applied to the connector 100 and can also be applied to other devices (such as flexible circuit boards). The connecting terminal 3 is made of conductive materials such as copper, and the connecting terminal 3 has a terminal body 31. A mounting hole 32 is formed in the terminal body 31. The mounting hole 32 can be a round hole, but it is not limited thereto. The mounting hole 32 extends to one end of the terminal body 31, and a depth of the mounting hole 32 is not limited in the present disclosure. However, a depth of the mounting hole 32 needs to allow the mounting hole 32 to at least accommodate the fork portion 21 of the fork-shaped terminal 2. A wire diameter of the conductive wire is smaller than a diameter of the mounting hole. A plurality of connection terminals 3 are provided in this embodiment. The connection terminals 3 are arranged at intervals, such that the mounting holes 32 are also arranged at intervals. The mounting holes 32 respectively correspond to the conductive wires 1, and the mounting holes 32 can be arranged in a row to facilitate the connection and fixing of the conductive wires 1.

In this embodiment, a diameter D of each of the mounting holes 32 may range from 0.7 mm to 1.1 mm, and the diameter D of the mounting hole 32 is preferably 0.9 mm. A wire diameter d of the conductive wire 1 is smaller than the diameter D of the mounting hole 32. The wire diameter d of the conductive wire 1 can range from 0.3 mm to 0.6 mm, and the wire diameter d of the conductive wire 1 preferably ranges from 0.4 mm to 0.5 mm.

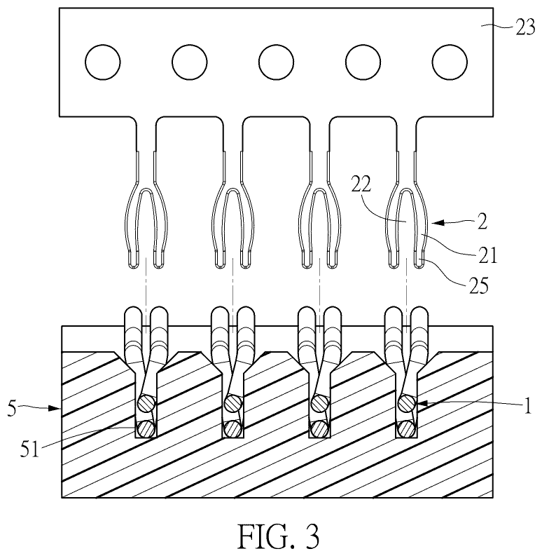

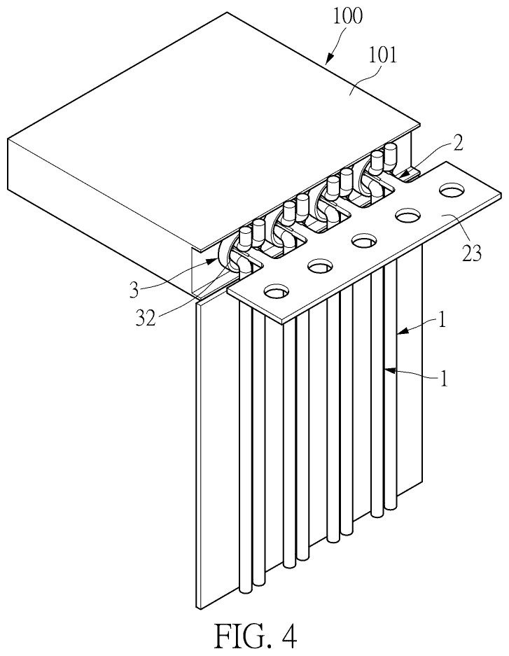

In this embodiment, multiple (for example, two) conductive wires 1 can be assembled together in the same mounting hole 32. During assembly, the multiple conductive wires 1 can be inserted into a channel 51 of a jig 5 beforehand (as shown in FIG. 3), so as to allow the plurality of conductive wires 1 originally arranged horizontally to be arranged vertically in the channel 51 of the jig 5. The fork-shaped terminal 2 is then pressed in a top-down manner, such that the conductive wire 1 is accommodated in the accommodation space 22 of the fork-shaped terminal 2, and the conductive wire 1 is covered by the fork portion 21 of the fork-shaped terminal 2. Then, the jig 5 is removed. Accordingly, the fork portion 21 of the fork-shaped terminal 2 and the conductive wire 1 are pressed into the mounting hole 32 of the connection terminal 3 (as shown in FIG. 4), and the fork portion 21 of the fork-shaped terminal 2 and the mounting hole 32 of the connection terminal 3 form an inference fit. By using the guiding of the fork-shaped terminal 2 and the friction force on the outside the fork-shaped terminal 2, pressing the fork portion 21 into the mounting hole 32 is smooth and pulling the fork portion 21 out of the mounting hole 32 is difficult. The inner wall of the mounting hole 32 of the connection terminal 3 abuts against the fork portion 21 of the fork-shaped terminal 2, and the conductive wire 1 is clamped in the fork portion 21 of the fork-shaped terminal 2, so as to connect and fix the conductive wire 1 and the connection terminal 3 together. In addition, the fork-shaped terminal 2 and the connection terminal 3 can be further glued and fixed to achieve a more stable bonding between the fork-shaped terminal 2 and the connection terminal 3.

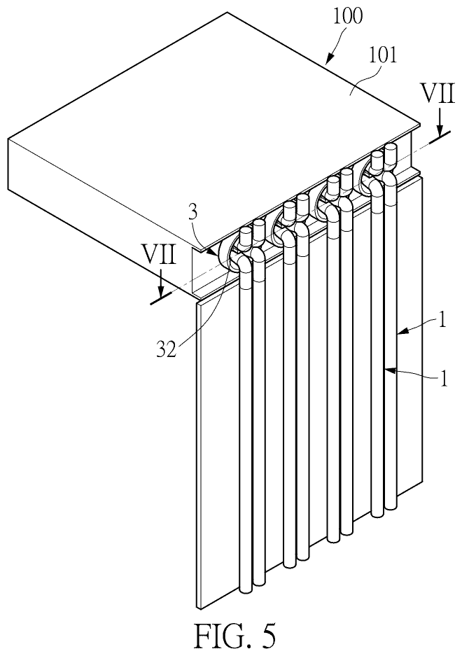

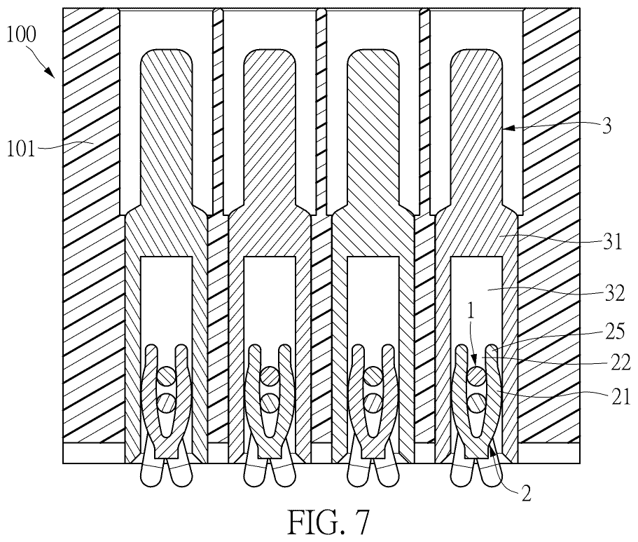

Finally, the material tape 23 of the entire row of fork-shaped terminals 2 are removed from the break line 24 of the fork-shaped terminals 2 (as shown in FIG. 5 and FIG. 7). The friction force exerted by the expansion force of the fork-shaped terminal 2 remaining in the mounting hole 32 on the inner wall of the mounting hole 32 can effectively prevent the installed conductive wire 1 from being pulled out.

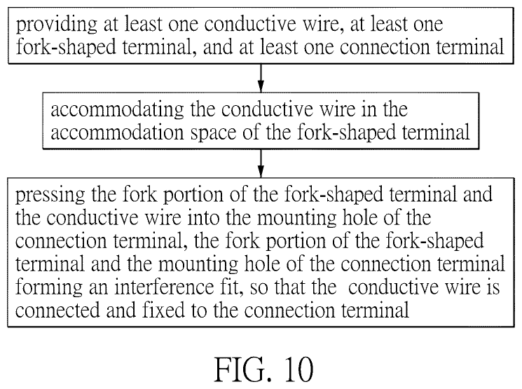

Referring to FIG. 10, the present disclosure further provides a quick connection method for a conductive wire and a connection terminal, which includes the following steps.

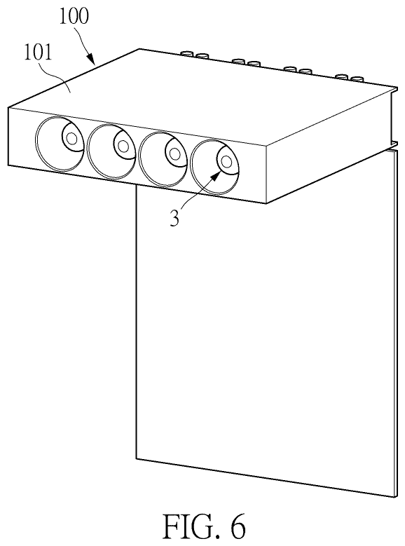

First, at least one conductive wire 1, at least one fork-shaped terminal 2, and at least one connection terminal 3 are provided (as shown in FIG. 1 to FIG. 7). The structures of the conductive wire 1, the fork-shaped terminal 2, and the connection terminal 3 are the same as those in the above-mentioned embodiment, and will not be reiterated herein.

Then, the conductive wire 1 can be inserted into the channel 51 of the jig 5, such that the conductive wire 1 originally arranged horizontally can be arranged vertically in each of the channels 51 of the jig 5, and then the fork-shaped terminals 2 can be pressed in the channel 51. Accordingly, the conductive wire 1 is accommodated in the accommodation space 22 of the fork-shaped terminal 2, and the conductive wire 1 is covered by the fork portion 21 of the fork-shaped terminal 2.

Afterwards, the fork portion 21 of the fork-shaped terminal 2 and the conductive wire 1 are pressed into the mounting hole 32 of the connection terminal 3. An interference fit is formed between the fork portion 21 of the fork-shaped terminal 2 and the mounting hole 32 of the connection terminal 3. By using the guiding of the fork-shaped terminal 2 and the friction force on the outside the fork-shaped terminal 2, pressing the fork portion 21 into the mounting hole 32 is smooth and pulling the fork portion 21 out of the mounting hole 32 is difficult. An adhesive can also be further dispensed between the fork-shaped terminal 2 and the connection terminal 3 for fixing the fork-shaped terminal 2 and the connection terminal 3 together.

Finally, the material tape 23 of the entire row of fork-shaped terminals 2 is removed along the break line 24 of the fork-shaped terminal 2. The friction force exerted by the expansion force of the fork-shaped terminal 2 remaining in the mounting hole 32 on the inner wall of the mounting hole 32 can effectively prevent the installed conductive wire 1 from being pulled out. In this way, the connection and fixing of the conductive wire 1 and the connection terminal 3 can be completed, and the conductive wire 1 and the connection terminal 3 are electrically connected and can be used for electrical signal transmission.

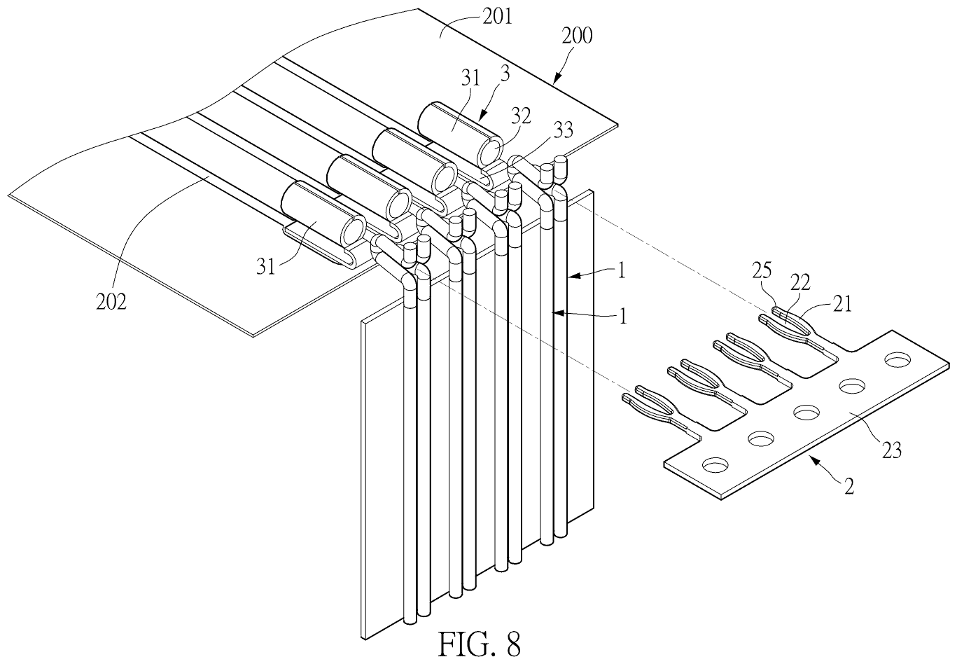

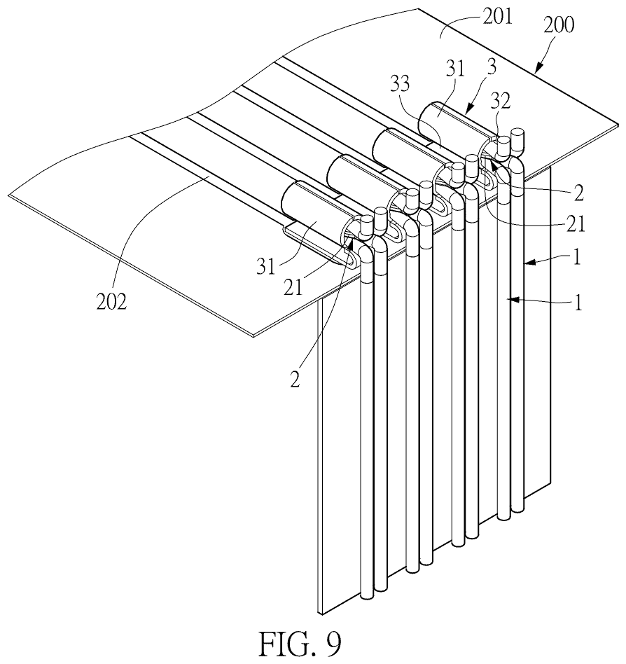

Referring to FIG. 8 and FIG. 9, in this embodiment, the connection terminal 3 can be applied to a flexible printed circuit (FPC). A flexible circuit board 200 includes a flexible board body 201. A plurality of connection terminals 3 are mounted on the flexible board body 201. The connection terminals 3 are transfer terminals, and the connection terminals 3 can be soldered on the flexible board body 201. In this embodiment, each of the connection terminals 3 has a terminal body 31. The mounting hole 32 is formed in the terminal body 31, and the mounting hole 32 extends to one end of the terminal body 31. The terminal body 31 extends to form a soldering portion 33, and the soldering portion can be soldered to a circuit wire 202 on the flexible board body, such that the connection terminal 3 is electrically connected to the flexible circuit board 200. The conductive wire 1 is accommodated in the accommodation space 22 of the fork-shaped terminal 2, the fork portion 21 of the fork-shaped terminal 2 and the conductive wire 1 are pressed into the mounting hole 32 of the connection terminal 3, and the fork portion 21 of the fork-shaped terminal 2 and the mounting hole 32 of the connection terminal 3 form an inference fit. The conductive wire 1 is clamped in the fork portion 21 of the fork-shaped terminal 2, so as to connect and fix the conductive wire 1 and the connection terminal 3 together.

### Beneficial Effects of the Embodiments

In conclusion, in the quick connection structure and the quick connection method for a conductive wire and a connection terminal provided by the present disclosure, the quick connection structure includes at least one conductive wire, at least one fork-shaped terminal, and at least one connection terminal. One end of the fork-shaped terminal has a fork portion, and an accommodation space is defined in the fork portion. The connection terminal includes a terminal body, at least one mounting hole is formed in the terminal body, the at least one mounting hole extends to one end of the terminal body, and a wire diameter of the conductive wire is smaller than a diameter of the mounting hole. The conductive wire is accommodated in the accommodation space of the fork-shaped terminal, the fork portion of the fork-shaped terminal and the conductive wire are pressed into the mounting hole of the connection terminal, and the fork portion of the terminal and the mounting hole of the connection terminal form an interference fit. The conductive wire is clamped in the fork portion of the fork-shaped terminal, so that the conductive wire is connected and fixed to the connection terminal. Accordingly, by the guiding of the fork-shaped terminal and friction force at the outer side of the fork-shaped terminal, pressing the fork portion into the mounting hole is smooth and pulling the fork portion out of the mounting hole is difficult. That is, the fork-shaped terminal that remains in the mounting hole exerts a force of expansion providing a friction force to an inner wall of the mounting hole, thereby effectively preventing the conductive wire from being pulled out. The quick connection structure and the quick connection method for a conductive wire and a connection terminal provided by the present disclosure can connect and fix the conductive wire and the connection terminal in a quick and simple assembly without using solder and be environmentally-friendly. Furthermore, the quick connection structure and method can be used to process materials that are not resistant to high temperature, and can achieve effects of convenient and fast for being used in mass production.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A quick connection structure, comprising:
at least one conductive wire;
at least one fork-shaped terminal, wherein one end of the fork-shaped terminal has a fork portion, the fork portion is bifurcated, and an accommodation space is defined in the fork portion; and
at least one connection terminal having a terminal body, wherein at least one mounting hole is formed in the terminal body, the mounting hole extends to one end of the terminal body, and a wire diameter of the conductive wire is smaller than a diameter of the mounting hole;
wherein the conductive wire is accommodated in the accommodation space of the fork-shaped terminal, the fork portion of the fork-shaped terminal and the conductive wire are pressed into the mounting hole of the connection terminal, and the fork portion of the terminal and the mounting hole of the connection terminal form an interference fit; wherein the conductive wire is clamped in the fork portion of the fork-shaped terminal, so that the conductive wire is connected and fixed to the connection terminal.

2. The quick connection structure according to claim 1, wherein a width of the accommodation space tapers inward, a guide portion is formed at one end of the fork portion, a width of the guide portion is smaller than a width of the fork portion, and the guide portion is rounded.

3. The quick connection structure according to claim 1, wherein the diameter of the mounting hole ranges from 0.7 mm to 1.1 mm, and the wire diameter of the conductive wire ranges from 0.3 mm to 0.6 mm.

4. The quick connection structure according to claim 1, wherein the conductive wire is plural in quantity, and the plurality of conductive wires are arranged horizontally; wherein the plurality of conductive wires are sheathed into a channel of a jig beforehand, so that the plurality of conductive wires originally arranged horizontally are arranged vertically; wherein the fork-shaped terminal is pressed into the jig, so that the plurality of conductive wires in the channel are covered by the fork portion of the fork-shaped terminal.

5. The quick connection structure according to claim 1, wherein the connection terminal is disposed in a connector body or on a flexible board body.

6. A quick connection method for a conductive wire and a connection terminal, comprising processes of:
providing at least one conductive wire, at least one fork-shaped terminal, and a connection terminal, wherein one end of the fork-shaped terminal has a fork portion, the fork portion is bifurcated, and an accommodation space is defined in the fork portion; wherein the connection terminal has a terminal body, at least one mounting hole is formed in the terminal body, the mounting hole extends to one end of the terminal body, and a wire diameter of the conductive wire is smaller than a diameter of the mounting hole;
accommodating the conductive wire in the accommodation space of the fork-shaped terminal; and
pressing the fork portion of the fork-shaped terminal and the conductive wire into the mounting hole of the connection terminal, so that the fork portion of the fork-shaped terminal and the mounting hole of the connection terminal form an interference fit; wherein the conductive wire is clamped in the fork portion of the fork-shaped terminal, so that the conductive wire is connected and fixed to the connection terminal.

7. The quick connection method according to claim 6, wherein the fork portion is connected to a material tape, and a break line is disposed between the fork portion and the material tape; wherein, after the fork portion and the conductive wire are pressed into the mounting hole of the connection terminal, the fork portion and the material tape are separated by breaking along the break line.

8. The quick connection method according to claim 6, wherein a width of the accommodation space tapers inward, a guide portion is formed at one end of the fork portion, a width of the guide portion is smaller than a width of the fork portion, and the guide portion is rounded and is capable of guiding the fork portion of the fork-shaped terminal to be inserted into the mounting hole of the connection terminal.

9. The quick connection method according to claim 6, wherein the diameter of the mounting hole ranges from 0.7 mm to 1.1 mm, and the wire diameter of the conductive wire ranges from 0.3 mm to 0.6 mm.

10. The quick connection method according to claim 6, wherein the conductive wire is plural in quantity, and the plurality of conductive wires are arranged horizontally; wherein the plurality of conductive wires are sheathed into a channel of a jig beforehand, so that the plurality of conductive wires originally arranged horizontally are arranged vertically; wherein the fork-shaped terminal is pressed into the jig, so that the plurality of conductive wires in the channel are covered by the fork portion of the fork-shaped terminal.

11. The quick connection method according to claim 6, wherein the connection terminal is disposed in a connector body or on a flexible board body.
